(19) United States
(12) Patent Application Publication
(10) Pub. No.: US 2024/0262227 A1
(43) Pub. Date: Aug. 8, 2024

(54) CHARGING DEVICE

(71) Applicant: PEGATRON CORPORATION, TAIPEI CITY (TW)

(72) Inventors: Yu-Lun Lin, Taipei City (TW); Yu-Hao Chiu, Taipei City (TW)

(73) Assignee: PEGATRON CORPORATION, TAIPEI CITY (TW)

(21) Appl. No.: 18/538,838

(22) Filed: Dec. 13, 2023

(30) Foreign Application Priority Data
Feb. 2, 2023 (TW) 112103601

(51) Int. Cl. B60L 53/31; B60L 53/16; B60L 53/18; H01R 13/52

(52) U.S. Cl. CPC B60L 53/31; B60L 53/16; B60L 53/18; H01R 13/5202

(57) ABSTRACT

A charging device includes a charging pile, a pulley set, a charging cable, a charging gun, and a positioning member. The charging pile has an inner space and a top opening. The pulley set is disposed in the inner space. The charging cable has a fixed end wound on the pulley set and a connecting end extending out of the inner space through the top opening. The charging gun includes a grip part, a charging connector, and a cable connecting part. The connecting end of the charging cable is inserted into the cable connecting part. The cable connecting part has a connecting hole and a limiting slot located in the connecting hole. The positioning member is sleeved on the connecting end and located in the connecting hole. The positioning member has a limiting part, and the limiting part is slidably disposed in the limiting slot.

### CROSS-REFERENCE TO RELATED APPLICATION

This application claims the priority benefit of Taiwan application serial no. 112103601, filed on Feb. 2, 2023. The entirety of the above-mentioned patent application is hereby incorporated by reference herein and made a part of this specification.

### BACKGROUND

### Technical Field

The disclosure relates to a charging technology, and in particular, to a charging device.

### Description of Related Art

In order to meet the charging needs of electric vehicles, the establishment of widespread charging stations has become an inevitable trend. Generally speaking, the charging gun is pluggably installed on the charging pile and receives power from the charging pile through the charging cable. Since the charging cable is extremely heavy, it is not only difficult for the user to drag it, but also difficult for the user to receive it. On the other hand, when the user holds the charging gun, the connecting point between the charging cable and the charging gun is mostly located behind or below the hand-held part of the charging gun. Under the pull of the charging cable, the user holding the charging gun needs to expend a lot of effort to drag the charging cable, rotate the charging gun, or insert the charging connector of the charging gun into the charging port on the electric vehicle. In addition, when the charging cable is frequently pulled, the charging gun is frequently rotated, or the charging gun is overly rotated, etc., the charging cable may easily become loose or worn at the connecting point with the charging gun, resulting in charging malfunction or operational safety issues.

### SUMMARY

The disclosure provides a charging device, which is not only convenient for users to operate, but also has excellent operational reliability.

This disclosure provides a charging device including a charging pile, a pulley set, a charging cable, a charging gun, and a positioning member. The charging pile has an inner space and a top opening connected to the inner space. The pulley set is disposed in the inner space. The charging cable has a fixed end and a connecting end opposite to each other. The fixed end is wound on the pulley set. The connecting end extends out of the inner space through the top opening. The charging gun includes a grip part, a charging connector, and a cable connecting part located between the grip part and the charging connector. The connecting end of the charging cable is inserted into the cable connecting part such that the charging gun is adapted to rotate relative to the charging cable. The cable connecting part has a connecting hole and a limiting slot located in the connecting hole. The positioning member is sleeved on the connecting end and located in the connecting hole. The positioning member has a limiting part, and the limiting part is slidably disposed in the limiting slot to limit a rotation angle of the charging gun rotating relative to the charging cable.

Based on the above, when the user holds the charging gun, the connecting point between the charging cable and the charging gun is located above the charging gun, and the pulley set may share the weight of the charging cable, so that the user may move the charging gun and drag the charging cable effortlessly and smoothly. On the other hand, the connecting point between the charging cable and the charging gun uses the limiting part and the limiting slot to limit the rotation angle of the charging gun rotating relative to the charging cable, so that the charging cable may be prevented from becoming loose or worn due to excessive rotation.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1A and FIG. 1B are schematic diagrams of a charging device in two different states according to an embodiment of the disclosure.

FIG. 2A is a schematic diagram of a charging gun according to an embodiment of the disclosure.

FIG. 2B and FIG. 2C are schematic diagrams of the charging gun of FIG. 2A after rotating.

FIG. 3A and FIG. 3B are schematic diagrams of a charging device in two different states according to another embodiment of the disclosure.

### DESCRIPTION OF THE EMBODIMENTS

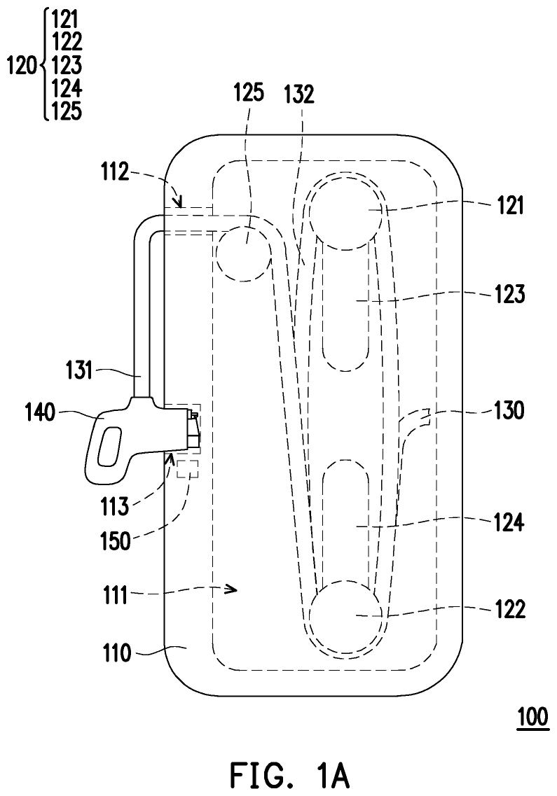

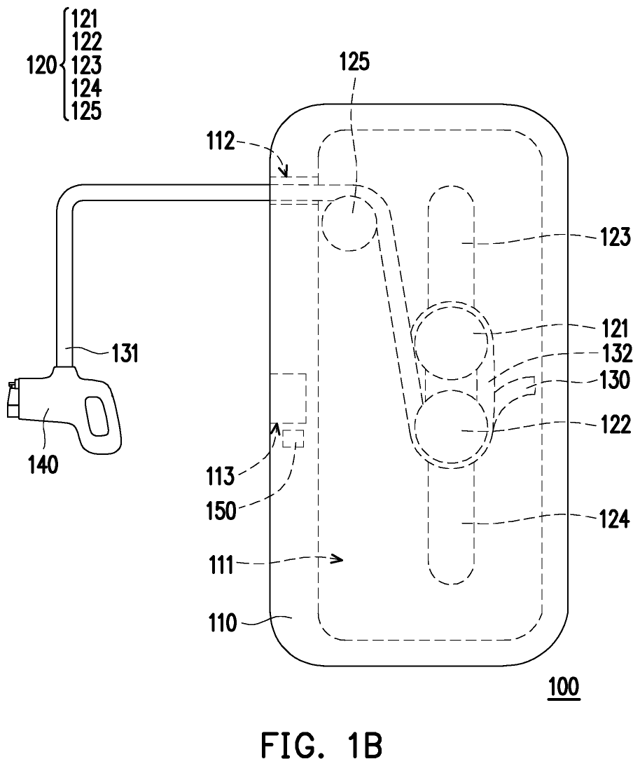

FIG. 1A and FIG. 1B are schematic diagrams of a charging device in two different states according to an embodiment of the disclosure. Referring to FIG. 1A, in the embodiment, a charging device 100 may be the charging equipment of an electric vehicle and includes a charging pile 110, a pulley set 120, a charging cable 130, and a charging gun 140. The charging pile 110 has an inner space 111 and a top opening 112 connected to the inner space 111. The inner space 111 may be configured to store the charging cable 130, which not only prevents the charging cable 130 from being scattered outside and affecting the appearance, but also helps improve the safety of drivers, passengers, passers-by, or pedestrians. In addition, when the charging cable 130 is stored in the inner space 111 of the charging pile 110, the charging cable 130 may be protected from wind, sun, and rain, which helps to improve safety and longevity.

Referring to FIG. 1A and FIG. 1B, the pulley set 120 is disposed in the inner space 111, and the charging cable 130 is coupled to the pulley set 120. In detail, the charging cable 130 has a connecting end 131 and a fixed end 132 opposite to each other. The fixed end 132 is wound on the pulley set 120, and the connecting end 131 extends out of the inner space 111 through the top opening 112 to be connected to the charging gun 140. When the user holds the charging gun 140, the connecting point between the connecting end 131 of the charging cable 130 and the charging gun 140 is located above the charging gun 140, and the pulley set 120 may share the weight of the charging cable 130, so that the user may move the charging gun 140 and drag the charging cable 130 effortlessly and smoothly.

In the embodiment, the pulley set 120 includes a first movable pulley 121, a second movable pulley 122, and a fixed pulley 125. The first movable pulley 121 and the second movable pulley 122 are located on the same side of the fixed pulley 125, and the first movable pulley 121 and the second movable pulley 122 are arranged in a straight line. The fixed pulley 125 is disposed corresponding to the top opening 112 and located between the top opening 112 and the first movable pulley 121. On the other hand, the fixed end 132 of the charging cable 130 is wound on the first movable pulley 121 and the second movable pulley 122 and slidably connected to the fixed pulley 125. In detail, the first movable pulley 121 and the second movable pulley 122 are adapted to retract the charging cable 130, and the fixed pulley 125 is adapted to guide the charging cable 130 to the top opening 112.

As shown in FIG. 1A, there is a first distance between the first movable pulley 121 and the second movable pulley 122, and the charging cable 130 is in a storage state. As shown in FIG. 1B, there is a second distance less than the first distance between the first movable pulley 121 and the second movable pulley 122, and the charging cable 130 is in a released state.

As shown in FIG. 1A and FIG. 1B, when the user takes out the charging gun 140 from the charging pile 110 and moves the charging gun 140 away from the charging pile 110, the first movable pulley 121, the second movable pulley 122, and the fixed pulley 125 in contact with the charging cable 130 may rotate, so that the user may move the charging gun 140 and drag the charging cable 130 effortlessly and smoothly. In detail, the first movable pulley 121 and the second movable pulley 122 slide along opposite directions to be close to each other to release the charging cable 130 outward, so that the length of the charging cable 130 exposed outside the top opening 112 is lengthened. By contrast, the length of the charging cable 130 stored in the inner space 111 is shortened.

When the user hangs the charging gun 140 back to the charging pile 110, the first movable pulley 121 and the second movable pulley 122 slide along opposite directions to move away from each other to retract the charging cable 130 inward, so that the length of the charging cable 130 exposed outside the top opening 112 is shortened. By contrast, the length of the charging cable 130 stored in the inner space 111 is lengthened.

As shown in FIG. 1A and FIG. 1B, in the embodiment, the pulley set 120 further includes a first linear slide rail 123 and a second linear slide rail 124. The first movable pulley 121 is slidably disposed on the first linear slide rail 123, and the second movable pulley 122 is slidably disposed on the second linear slide rail 124. The first linear slide rail 123 and the second linear slide rail 124 may use a pneumatic driving mechanism or a hydraulic driving mechanism to drive the first movable pulley 121 and the second movable pulley 122 to slide along opposite directions in the inner space 111.

On the other hand, the charging pile 110 further has a gun hanging slot 113 and a sensor 150 disposed in the gun hanging slot 113, and the gun hanging slot 113 is located below the top opening 112. In the embodiment, the sensor 150 may be a contact sensor or a non-contact sensor adapted to sense whether the charging gun 140 is hung in the gun hanging slot 113.

As shown in FIG. 1B, when the user takes out the charging gun 140 from the gun hanging slot 113, the sensor 150 senses that the charging gun 140 moves away from the gun hanging slot 113 and sends a signal to a processor (not shown). The processor (not shown) activates the first linear slide rail 123 and the second linear slide rail 124 to drive the first movable pulley 121 and the second movable pulley 122 to slide close to each other, for example, to decrease the distance between the first movable pulley 121 and the second movable pulley 122 from the first distance to the second distance, so as to release the charging cable 130 outward.

As shown in FIG. 1A, when the user hangs the charging gun 140 back into the gun hanging slot 113, the sensor 150 senses that the charging gun 140 is hung in the gun hanging slot 113 and sends a signal to the processor (not shown). The processor (not shown) activates the first linear slide rail 123 and the second linear slide rail 124 to drive the first movable pulley 121 and the second movable pulley 122 to slide away from each other, for example, to increase the distance between the first movable pulley 121 and the second movable pulley 122 from the second distance to the first distance, so as to retract the charging cable 130 inwards.

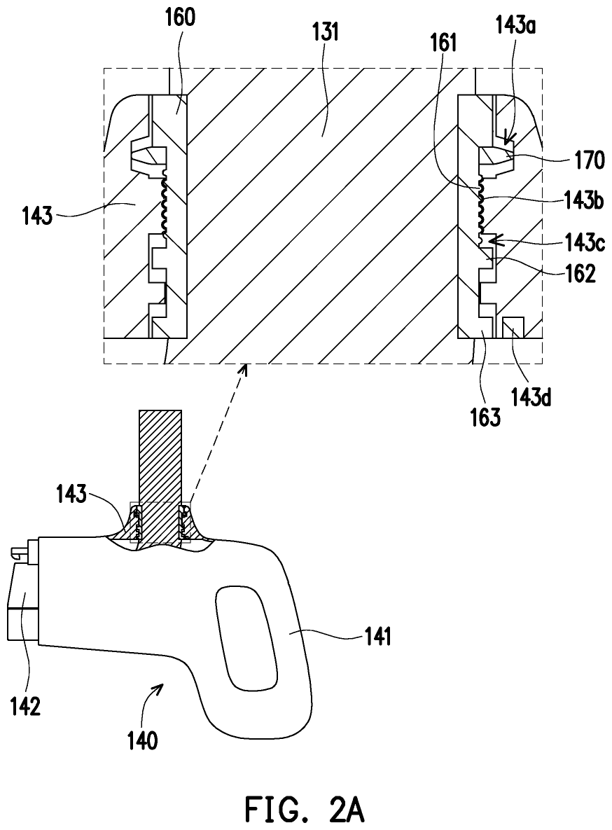

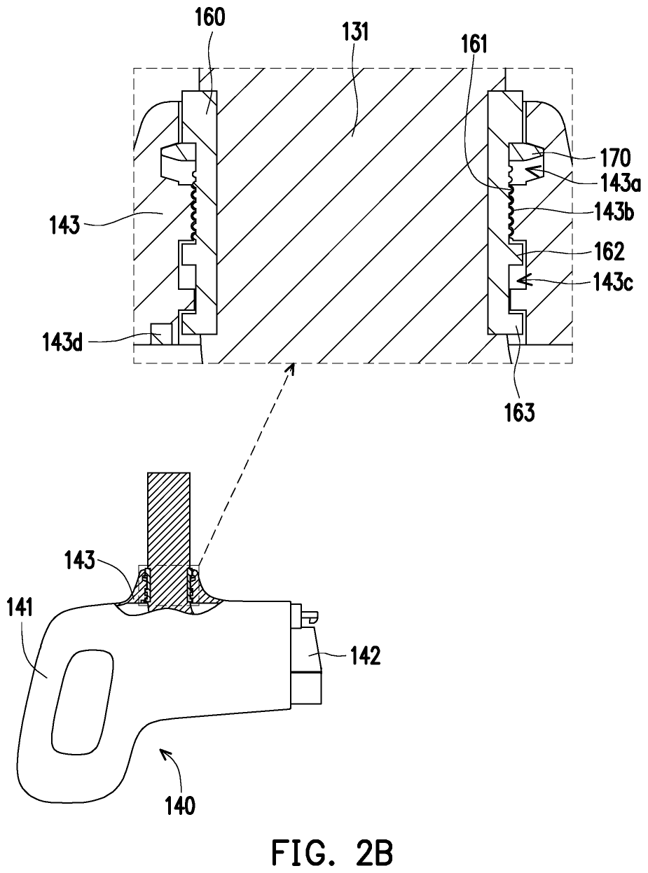

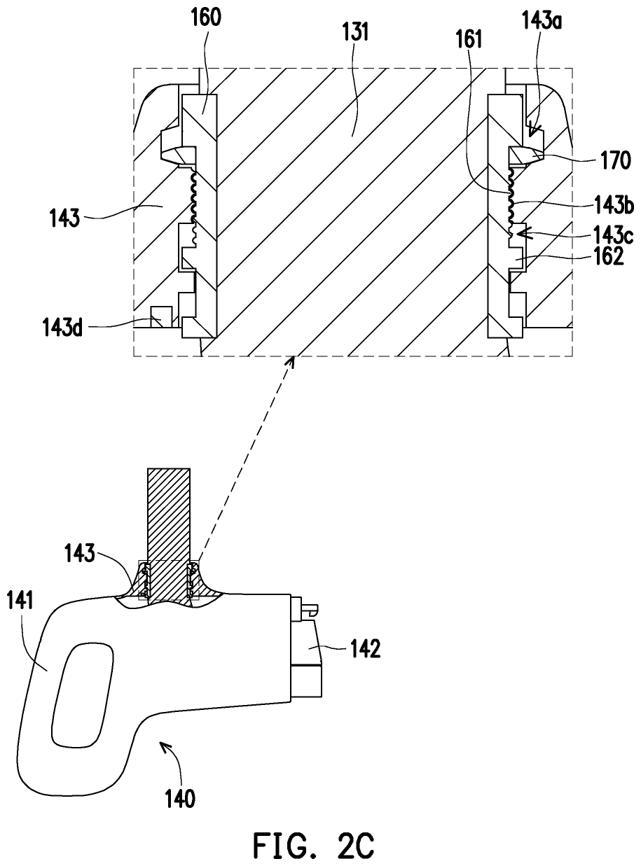

FIG. 2A is a schematic diagram of a charging gun according to an embodiment of the disclosure. FIG. 2B and FIG. 2C are schematic diagrams of the charging gun of FIG. 2A after rotating. Referring to FIG. 2A, in the embodiment, the charging gun 140 includes a grip part 141, a charging connector 142 opposite to the grip part 141, and a cable connecting part 143 between the grip part 141 and the charging connector 142, and the connecting end 131 of the charging cable 130 is inserted into the cable connecting part 143. In detail, the outlet position of the charging cable 130 from the charging gun 140 is located between the grip part 141 and the charging connector 142 and located above the charging gun 140, so that it is convenient for the user to pick and place, move, or rotate the charging gun 140. In addition, since there is a distance between the grip part 141 and the cable connecting part 143, the torque may be increased, so that the operation may be more effortless. In an embodiment, the cable connecting part 143 may be located at the middle of the grip part 141 and the charging connector 142, but the disclosure is not limited thereto.

In the embodiment, the cable connecting part 143 has a connecting hole 143a, an inner thread 143b located in the connecting hole 143a, and a limiting slot 143c located in the connecting hole 143a. On the other hand, the charging device 100 further includes a positioning member 160. The positioning member 160 is sleeved and fixed on the connecting end 131, and the positioning member 160 is located in the connecting hole 143a. In detail, the positioning member 160 has an outer thread 161 and a limiting part 162. The outer thread 161 is rotatably connected to the inner thread 143b, and the limiting part 162 is slidably disposed in the limiting slot 143c. For example, the limiting part 162 may be a limiting convex ring, and the limiting slot 143c may be an annular limiting slot, so that the limiting part 162 may rotate and slide within the limiting slot 143c to a limited extent.

As shown in FIG. 2A and FIG. 2B or FIG. 2A and FIG. 2C, when the user rotates the charging gun 140, the coordination between the outer thread 161 of the positioning member 160 and the inner thread 143b of the cable connecting part 143 may improve the rotation stability of the charging gun 140 rotating relative to the charging cable 130. In addition, the limiting part 162 of the positioning member 160 is limited to sliding up and down in the limiting slot 143c of the cable connecting part 143.

As shown in FIG. 2A and FIG. 2B, when the user rotates the charging gun 140 (for example, forward rotation), the limiting part 162 slides toward an upper wall surface of the limiting slot 143c. Once the limiting part 162 contacts the upper wall surface of the limiting slot 143c, the user may be unable to continue to rotate the charging gun 140 along the same direction. As shown in FIG. 2A and FIG. 2C, when the user rotates the charging gun 140 (for example, reverse rotation), the limiting part 162 slides toward a lower wall surface of the limiting slot 143c. Once the limiting part 162 contacts the lower wall surface of the limiting slot 143c, the user may be unable to continue to rotate the charging gun 140 along the same direction. That is to say, the coordination between the limiting part 162 of the positioning member 160 and the limiting slot 143c of the cable connecting part 143 may limit a rotation angle of the charging gun 140 rotating relative to the charging cable 130 (for example, plus or minus 180 degrees), so that the charging cable 130 may be prevented from becoming loose or worn due to excessive rotation.

As shown in FIG. 2A and FIG. 2B or FIG. 2A and FIG. 2C, in the embodiment, the positioning member 160 further has a magnetic part 163, and the limiting part 162 is located between the outer thread 161 and the magnetic part 163. In addition, the cable connecting part 143 is disposed with a magnet 143d corresponding to the magnetic part 163, and the limiting slot 143c is located between the inner thread 143b and the magnet 143d. In detail, the magnetic part 163 may be constructed of magnetically conductive material, and the magnet 143d is disposed corresponding to the magnetic part 163 for generating a magnetic attraction force to the magnetic part 163.

As shown in FIG. 2B or FIG. 2C, as the charging gun 140 rotates, the magnet 143d moves away from the magnetic part 163, and the magnetic attraction force generated by the magnet 143d to the magnetic part 163 weakens. Therefore, when the user rotates the charging gun 140 to return to the initial state shown in FIG. 2A from the rotating state of FIG. 2B or FIG. 2C, the magnetic attraction force generated by the magnet 143d to the magnetic part 163 enhances, and the user holding the charging gun 140 may feel the obvious positioning feel. When the magnet 143d is facing the magnetic part 163, the magnet 143d generates the maximum magnetic attraction force to the magnetic part 163, so that the user may detect that the charging gun 140 has rotated to the position and avoid excessive rotation of the charging gun 140.

As shown in FIG. 2A, in the embodiment, the charging device 100 further includes a waterproof ring 170 constructed of, for example, silicone, rubber, or other elastic waterproof materials, and the outer thread 161 is located between the waterproof ring 170 and the limiting part 162. In detail, the waterproof ring 170 is sleeved on the positioning member 160 and contacts an inner wall surface of the connecting hole 143a to prevent external moisture from entering the interior of the charging gun 140 through the connecting hole 143a and prevent the electronic parts or circuits inside the charging gun 140 from malfunctioning or being damaged due to moisture.

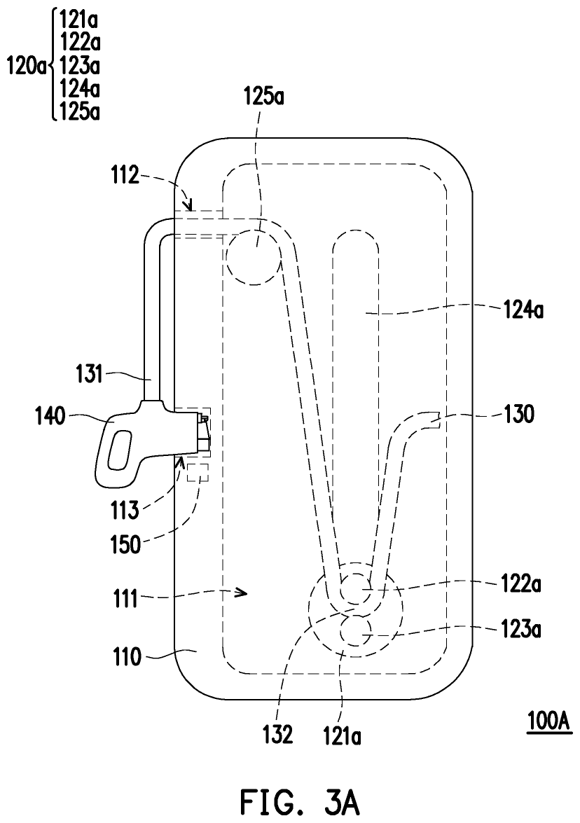

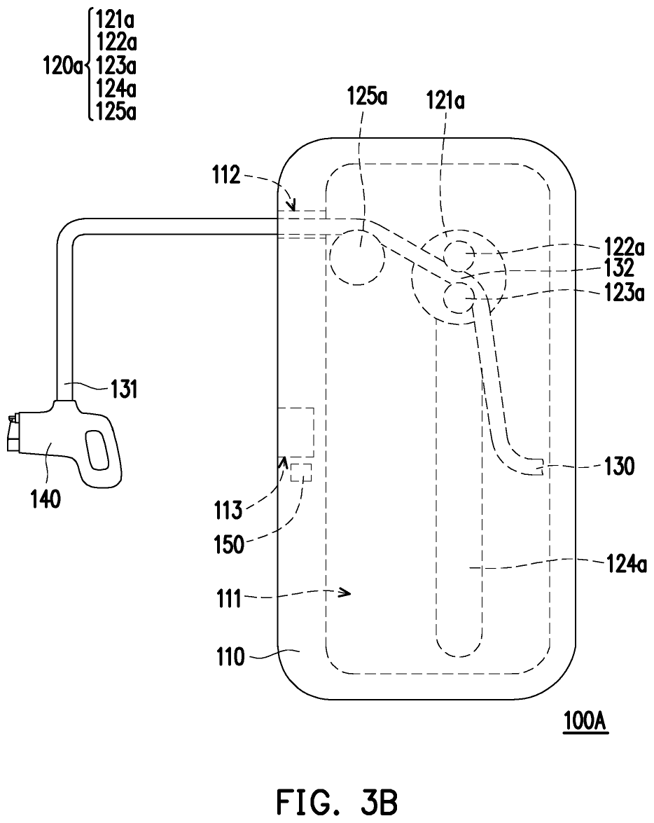

FIG. 3A and FIG. 3B are schematic diagrams of a charging device in two different states according to another embodiment of the disclosure. Referring to FIG. 3A and FIG. 3B., a charging device 100A of the embodiment has roughly the same design principle as the charging device 100 of the previous embodiment. The main difference between the two lies in the structural design of the pulley set.

In the embodiment, a pulley set 120a includes a movable pulley 121a, a first guide pulley 122a, a second guide pulley 123a, and a fixed pulley 125a. The first guide pulley 122a and the second guide pulley 123a are pivotally connected to the movable pulley 121a, and the fixed end 132 of the charging cable 130 is slidably connected between the first guide pulley 122a and the second guide pulley 123a. In addition, the fixed pulley 125a is disposed corresponding to the top opening 112 and adapted to guide the charging cable 130 from the movable pulley 121a to the top opening 112.

As shown in FIG. 3A and FIG. 3B, the first guide pulley 122a and the second guide pulley 123a slide synchronously, for example, slide up and down, in the inner space 111 along with the movable pulley 121a. As shown in FIG. 3A, the movable pulley 121a is located at a first position in the inner space 111, and the charging cable 130 is in a storage state. As shown in FIG. 3B, the movable pulley 121a is located at a second position in the inner space 111, and the charging cable 130 is in a released state. In detail, the second position is higher than the first position and closer to the fixed pulley 125a and the top opening 112 than the first position.

As shown in FIG. 3A and FIG. 3B, when the user takes out the charging gun 140 from the charging pile 110 and moves the charging gun 140 away from the charging pile 110, the first guide pulley 122a and the second guide pulley 123a in contact with the charging cable 130 may rotate, so that the user may move the charging gun 140 and drag the charging cable 130 effortlessly and smoothly. At the same time, the movable pulley 121a slides toward the second position to release the charging cable 130 outward, so that the length of the charging cable 130 exposed outside the top opening 112 is lengthened. By contrast, the length of the charging cable 130 stored in the inner space 111 is shortened.

When the user hangs the charging gun 140 back to the charging pile 110, the movable pulley 121a slides toward the first position to retract the charging cable 130 inward, so that the length of the charging cable 130 exposed outside the top opening 112 is shortened. By contrast, the length of the charging cable 130 stored in the inner space 111 is lengthened.

As shown in FIG. 3A and FIG. 3B, in the embodiment, the pulley set 120a further includes a linear slide rail 124a, and the movable pulley 121a is slidably disposed on the linear slide rail 124a. The linear slide rail 124a may use a pneumatic driving mechanism or a hydraulic driving mechanism to drive the movable pulley 121a to reciprocally slide between the first position and the second position.

As shown in FIG. 3B, when the user takes out the charging gun 140 from the gun hanging slot 113, the sensor 150 senses that the charging gun 140 moves away from the gun hanging slot 113 and sends a signal to a processor (not shown). The processor (not shown) activates the linear slide rail 124a to drive the movable pulley 121a to slide toward the second position to release the charging cable 130 outward.

As shown in FIG. 3A, when the user hangs the charging gun 140 back into the gun hanging slot 113, the sensor 150 senses that the charging gun 140 is hung in the gun hanging slot 113 and sends a signal to a processor (not shown). The processor (not shown) activates the linear slide rail 124a to drive the movable pulley 121a to slide toward the first position to retract the charging cable 130 inwards.

To sum up, when the user holds the charging gun, the connecting point between the charging cable and the charging gun is located above the charging gun, and the pulley set may share the weight of the charging cable, so that the user may move the charging gun and drag the charging cable effortlessly and smoothly. On the other hand, the connecting point between the charging cable and the charging gun uses the limiting part and the limiting slot to limit the rotation angle of the charging gun rotating relative to the charging cable, so that the charging cable may be prevented from becoming loose or worn due to excessive rotation. In addition, the connecting point between the charging cable and the charging gun uses the coordination of the outer thread and the inner thread to improve the rotation stability of the charging gun rotating relative to the charging cable. In addition, by sensing the usage status of the charging gun, the pulley set may automatically retract the charging cable to automatically recover the charging cable or facilitate the user to drag the charging cable.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure shall be defined in the appended claims.

What is claimed is:

1. A charging device, comprising:
a charging pile, having an inner space and a top opening connected to the inner space;
a pulley set, disposed in the inner space;
a charging cable, having a fixed end and a connecting end opposite to each other, wherein the fixed end is wound on the pulley set, and the connecting end extends out of the inner space through the top opening;
a charging gun, comprising a grip part, a charging connector opposite to the grip part, and a cable connecting part between the grip part and the charging connector, wherein the connecting end of the charging cable is inserted into the cable connecting part such that the charging gun is adapted to rotate relative to the charging cable, and the cable connecting part has a connecting hole and a limiting slot located in the connecting hole; and
a positioning member, sleeved on the connecting end, and located in the connecting hole, wherein the positioning member has a limiting part, and the limiting part is slidably disposed in the limiting slot to limit a rotation angle of the charging gun rotating relative to the charging cable.

2. The charging device according to claim 1, wherein the cable connecting part further has an inner thread in the connecting hole, the positioning member further has an outer thread, and the outer thread is rotatably connected to the inner thread.

3. The charging device according to claim 2, further comprising:
a waterproof ring, sleeved on the positioning member, and contacting an inner wall surface of the connecting hole, wherein the outer thread is located between the waterproof ring and the limiting part.

4. The charging device according to claim 2, wherein the positioning member further has a magnetic part, the limiting part is located between the outer thread and the magnetic part, the cable connecting part is disposed with a magnet corresponding to the magnetic part, the magnet generates a magnetic attraction force to the magnetic part, and the limiting slot is located between the inner thread and the magnet.

5. The charging device according to claim 1, wherein the pulley set comprises two movable pulleys, the fixed end of the charging cable is wound on the two movable pulleys, the two movable pulleys are adapted to slide in the inner space along opposite directions, a length of the charging cable exposed outside the top opening is shortened when the two movable pulleys slide away from each other, and the length of the charging cable exposed outside the top opening is lengthened when the two movable pulleys slide close to each other.

6. The charging device according to claim 5, wherein the charging pile further has a gun hanging slot and a sensor, the gun hanging slot is located below the top opening, the sensor is disposed in the gun hanging slot and adapted to sense the charging gun, the two movable pulleys slide away from each other when the sensor senses that the charging gun is hung in the gun hanging slot, and the two movable pulleys slide close to each other when the sensor senses that the charging gun leaves the gun hanging slot.

7. The charging device according to claim 5, wherein the pulley set further comprises two linear slide rails, and the two movable pulleys are slidably disposed on the two linear slide rails, respectively.

8. The charging device according to claim 1, wherein the pulley set comprises a movable pulley and two guide pulleys pivotally connected to the movable pulley, the fixed end of the charging cable is slidably connected between the two guide pulleys, the movable pulley is adapted to slide between a first position and a second position, the second position is closer to the top opening than the first position, a length of the charging cable exposed outside the top opening is shortened when the movable pulley slides toward the first position, and the length of the charging cable exposed outside the top opening is lengthened when the movable pulley slides toward the second position.

9. The charging device according to claim 8, wherein the charging pile further has a gun hanging slot and a sensor, the gun hanging slot is located below the top opening, the sensor is disposed in the gun hanging slot and adapted to sense the charging gun, the movable pulley slides to the first position when the sensor senses that the charging gun is hung in the gun hanging slot, and the movable pulley slides to the second position when the sensor senses that the charging gun leaves the gun hanging slot.

10. The charging device according to claim 8, wherein the pulley set further comprises a linear slide rail, and the movable pulley is slidably disposed on the linear slide rail.

11. The charging device according to claim 1, wherein the pulley set further comprises a fixed pulley disposed corresponding to the top opening, and the fixed end of the charging cable is slidably connected to the fixed pulley.
